(19) United States
(12) Patent Application Publication
(10) Pub. No.: US 2024/0407320 A1
(43) Pub. Date: Dec. 12, 2024

(54) SELF-CLEANING CAT LITTER BOX THAT AUTOMATICALLY SLIDES AND FLIPS OVER TO SCOOP OUT FECES AND OPEN LID

(71) Applicant: Dongguan KeAI Technology Co., Ltd, Dongguan (CN)

(72) Inventors: Lingjian Mo, Dongguan (CN); Jian Hu, Dongguan (CN)

(21) Appl. No.: 18/809,987

(22) Filed: Aug. 20, 2024

(51) Int. Cl. A01K 1/01

(52) U.S. Cl. CPC A01K 1/0107

(57) ABSTRACT

The present disclosure belongs to the technical field of cat litter boxes, and specifically discloses a self-cleaning cat litter box, including a box body, where a trash bin and a poop rake are housed in the box body, slides are disposed on both sides of the trash bin, a flipping drive mechanism is disposed in one of the slides, the top of the trash bin is covered with a trash lid, the poop rake and the trash lid are both hinged to the two slides and flip over synchronously, and the trash bin, the poop rake, and the trash lid are all slidingly connected to the box body. By using the present disclosure, not only the cleaning process is simplified, but also the cleaning efficiency and effect are effectively improved.

### TECHNICAL FIELD

The present disclosure belongs to the technical field of cat litter boxes, and in particular, relates to a self-cleaning cat litter box that automatically slides and flips over to scoop out feces and open a lid.

### BACKGROUND

Cat litter is an object used to bury cat feces and urine, and is highly absorbent and usually used together with a cat litter box. In the daily care of pet cats, the cleaning and maintenance of cat litter boxes is an important and frequent task. Traditional cat litter boxes require manual cleaning of cat excrement regularly, which is not only time-consuming and labor-intensive, but may also cause hygiene problems due to contact with unclean objects.

In recent years, with the development of smart homes, a variety of automated cat litter boxes have appeared on the market, aiming to reduce the burden on pet owners and improve cleaning efficiency. However, in existing automated cat litter boxes, the trash bin and poop rake are located at both ends of the cat litter box, respectively. During the poop scooping process, the poop rake needs to slide from one end to the other end of the cat litter box until the cat feces are gathered together, and the cat's feces can be scooped directly into the trash bin. Moreover, the lid needs to be opened manually before scooping, which brings a lot of inconvenience to the user. Once the user forgets to open the lid, the cat litter box cannot work properly. The entire cat litter box has problems such as cumbersome operation and incomplete cleaning, and it is difficult to meet the user's comprehensive needs for convenience, efficiency and hygiene.

Therefore, the inventor is committed to designing a cat litter box to solve the above problems.

### SUMMARY

An object of the present disclosure is to provide a self-cleaning cat litter box that automatically slides and flips over to scoop out feces and open a lid. Not only the cleaning process is simplified, and the cleaning efficiency and effect are improved, but also the complexity and labor intensity of manual operations are greatly reduced.

In order to achieve the above object, a technical solution adopted by the present disclosure is as follows:

A self-cleaning cat litter box that automatically slides and flips over to scoop out feces and open a lid, including a box body, where a trash bin and a poop rake are housed in the box body, the poop rake is located on the front side of the trash bin, slides are disposed on the left and right sides of the trash bin, a flipping drive mechanism is disposed in one of the slides, the top of the trash bin is covered with a trash lid, the poop rake and the trash lid are both hinged to the two slides and are driven by the flipping drive mechanism to flip over synchronously, and the trash bin, the poop rake, and the trash lid are all slidingly connected to the box body through the two slides.

As an improvement of the self-cleaning cat litter box that automatically slides and flips over to scoop out feces and open a lid of the present disclosure, a top end of the poop rake is hinged to the two slides through a rotary shaft, a rear end of the trash lid is hinged to the two slides through rotating shafts, and the poop rake and the trash lid flip over in the same direction.

As an improvement of the self-cleaning cat litter box that automatically slides and flips over to scoop out feces and open a lid of the present disclosure, a chute is disposed on an inner wall of each of the slides close to the trash bin, and both opposite edges of the box body are slidably hooked in the two chutes, respectively.

As an improvement of the self-cleaning cat litter box that automatically slides and flips over to scoop out feces and open a lid of the present disclosure, racks are respectively fixed at the bottoms of both opposite edges of the box body, the two racks are inserted into the two chutes in an one-to-one correspondence manner, sliding drive mechanisms are respectively disposed on the two slides, and sliding driven wheels of the sliding drive mechanisms are exposed in the chutes and mesh with the corresponding racks.

As an improvement of the self-cleaning cat litter box that automatically slides and flips over to scoop out feces and open a lid of the present disclosure, each of the slides is rotatably connected with a roller, and the rollers are exposed in the corresponding chutes and roll against an edge outer wall of the box body.

As an improvement of the self-cleaning cat litter box that automatically slides and flips over to scoop out feces and open a lid of the present disclosure, the flipping drive mechanism includes a flipping driving wheel, a second gear, a second dual gear, and a second driven wheel, the flipping driving wheel being rotatably arranged in the slides and driving the second driven wheel to rotate through the second gear and the second dual gear in turn, and the second driven wheel being sleeved on the rotating shafts of the trash lid.

As an improvement of the self-cleaning cat litter box that automatically slides and flips over to scoop out feces and open a lid of the present disclosure, the second dual gear includes a third gear and a fourth gear that are coaxially arranged, an end face of the third gear matching an end face of the fourth gear concavely and convexly, the third gear meshing with the second gear, and the fourth gear meshing with the second driven wheel.

As an improvement of the self-cleaning cat litter box that automatically slides and flips over to scoop out feces and open a lid of the present disclosure, the flipping drive mechanism further includes a first driven wheel and a gear set, the first driven wheel and the rotary shaft of the poop rake rotating synchronously, and the flipping driving wheel driving the first driven wheel to rotate through the gear set.

As an improvement of the self-cleaning cat litter box that automatically slides and flips over to scoop out feces and open a lid of the present disclosure, a slot is disposed on both the top and inner wall of each of the slides, an insertion strip is mounted in each slot, the insertion strips are slidably engaged in the slots to form insertion holes, and the rotary shaft of the poop rake extends into the insertion holes.

As an improvement of the self-cleaning cat litter box that automatically slides and flips over to scoop out feces and open a lid of the present disclosure, a limit wheel is rotatably disposed in one of the slides, the end of the rotary shaft of the poop rake is bent and located in the limit wheel, and the limit wheel is driven by the flipping drive mechanism to rotate; each of the slides includes a side plate, a fixing plate, and a cover plate, the side plates being located at the edge of the trash bin and being integrally formed with the trash bin, and the cover plates and the fixing plates fixedly covering the side plates in turn from the outside to the inside, respectively; the opening of the trash bin is magnetically connected with a fixing frame, the top of the box body is hollow and a boss is provided inside, the trash bin is movably disposed on the boss, and a deodorizing device is disposed on the trash lid.

Compared with the prior art, according to the self-cleaning cat litter box that automatically slides and flips over to scoop out feces and open a lid of the present disclosure, the flipping drive mechanism is used to control the poop rake and trash lid to flip over synchronously, and the trash bin, the poop rake, and the trash lid slide together on the box body, so that the synchronization of the actions of scooping and lid opening is realized, and the cat's excrement can be scooped into the trash bin in time. By using the entire cat litter box, not only the cleaning process is simplified, and the cleaning efficiency and effect are improved, but also the complexity and labor intensity of manual operations are greatly reduced.

### BRIEF DESCRIPTION OF THE DRAWINGS

FIG. 1 is a three-dimensional enlarged view of a self-cleaning cat litter box that automatically slides and flips over to scoop out feces and open a lid of the present disclosure;

FIG. 2 is a three-dimensional exploded view of the self-cleaning cat litter box that automatically slides and flips over to scoop out feces and open a lid of the present disclosure;

FIG. 3 is a three-dimensional exploded view of the self-cleaning cat litter box that automatically slides and flips over to scoop out feces and open a lid of the present disclosure;

FIG. 4 is a three-dimensional enlarged view of a right fixing plate, a flipping drive mechanism, and a sliding drive mechanism of the present disclosure;

FIG. 5 is a three-dimensional enlarged view of the right fixing plate of the present disclosure from another perspective;

FIG. 6 is a three-dimensional enlarged view of a left fixing plate of the present disclosure;

FIG. 7 is a three-dimensional enlarged view of the left fixing plate of the present disclosure from another perspective;

FIG. 8 is a three-dimensional enlarged view of an insertion strip of the present disclosure;

FIG. 9 is a partially exploded enlarged view of the self-cleaning cat litter box that automatically slides and flips over to scoop out feces and open a lid of the present disclosure;

FIG. 10 is a three-dimensional enlarged view of a box body and racks of the present disclosure;

FIG. 11 is a three-dimensional enlarged view of a poop rake, a trash lid and a flipping drive mechanism of the present disclosure;

FIG. 12 is a cross-sectional enlarged view of the flipping drive mechanism of the present disclosure;

FIG. 13 is a three-dimensional exploded view of a second dual gear of the present disclosure;

FIG. 14 is a three-dimensional exploded view of the second dual gear of the present disclosure from another perspective;

FIG. 15 is a three-dimensional enlarged view of a trash bin and a poop rake of the present disclosure;

FIG. 16 is a cross-sectional enlarged view of the trash bin and the poop rake of the present disclosure;

FIG. 17 is an enlarged view of A in FIG. 16;

FIG. 18 is a partially exploded enlarged view of the self-cleaning cat litter box that automatically slides and flips over to scoop out feces and open a lid of the present disclosure;

FIG. 19 is an enlarged view of B in FIG. 18;

FIG. 20 is a three-dimensional enlarged view of the trash bin, two racks and two slides of the present disclosure; and

FIG. 21 is a three-dimensional enlarged view of the self-cleaning cat litter box that automatically slides and flips over to scoop out feces and open a lid of the present disclosure, with the poop rake and trash lid in a flipped state.

### ILLUSTRATION DESCRIPTION

1. box body; 11. boss; 12. rack; 2. trash bin; 21. fixing frame; 3. poop rake; 31. rotary shaft; 4. flipping drive mechanism; 41. flipping driving wheel; 42. gear set; 421. first gear; 422. first dual gear; 43. first driven wheel; 44. second dual gear; 441. third gear; 442. fourth gear; 443. ratchet teeth; 444. ratchet groove; 45. second driven wheel; 46. second gear; 5. sliding drive mechanism; 51. sliding driving wheel; 52. sliding driven wheel; 521. limit wheel; 522. limit hole; 6. left slide; 61. left side plate; 611. left slot; 62. left fixing plate; 621. left chute; 7. right slide; 71. right side plate; 711. right slot; 712. clamping table; 72. right fixing plate; 721. right chute; 722. auxiliary wheel; 8. left side cover; 81. right side cover; 82. left cover plate; 821. left sliding motor; 83. right cover plate; 831. flipping motor; 832. right sliding motor; 84. roller; 85. trash lid; 851. lid body; 852. top cover; 853. rotating shaft; 854. deodorizing hole; 9. insertion strip; 91. buckle; 92. limit portion.

### DETAILED DESCRIPTION

The following describes the implementations of the present disclosure in detail in conjunction with the accompanying drawings, which are for reference and illustration merely and do not limit the scope of patent protection of the present disclosure.

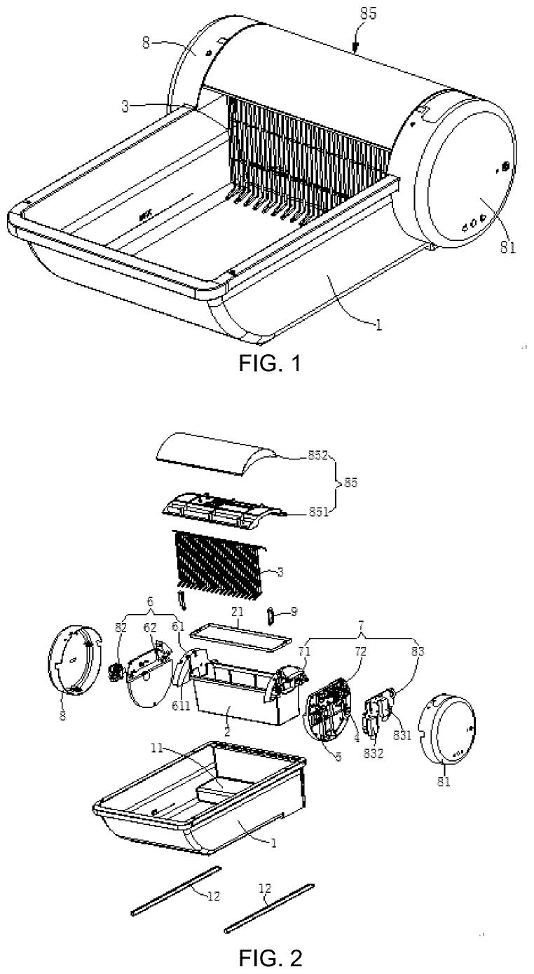

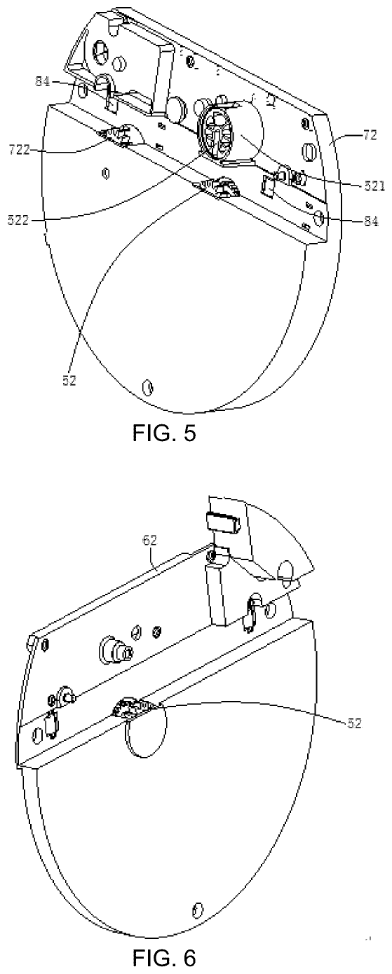

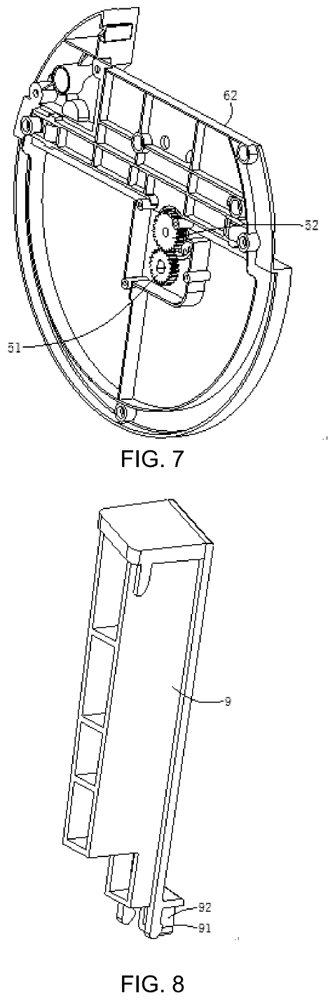

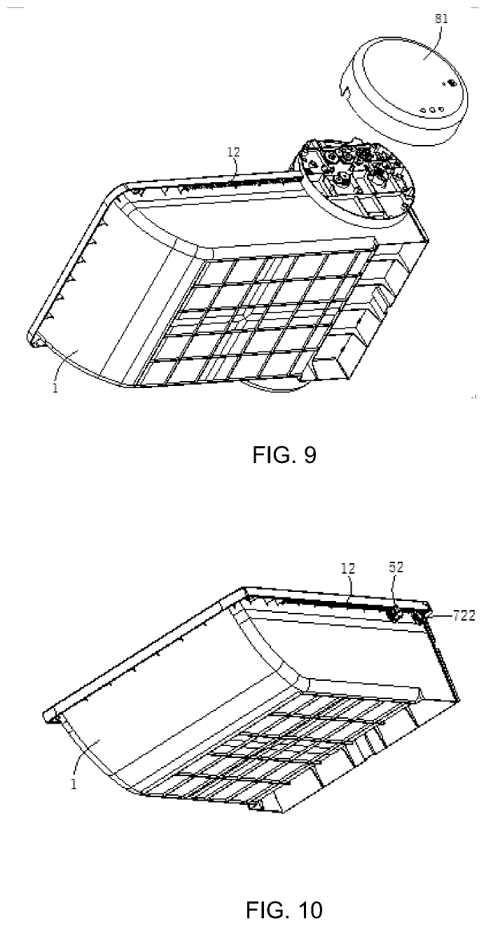

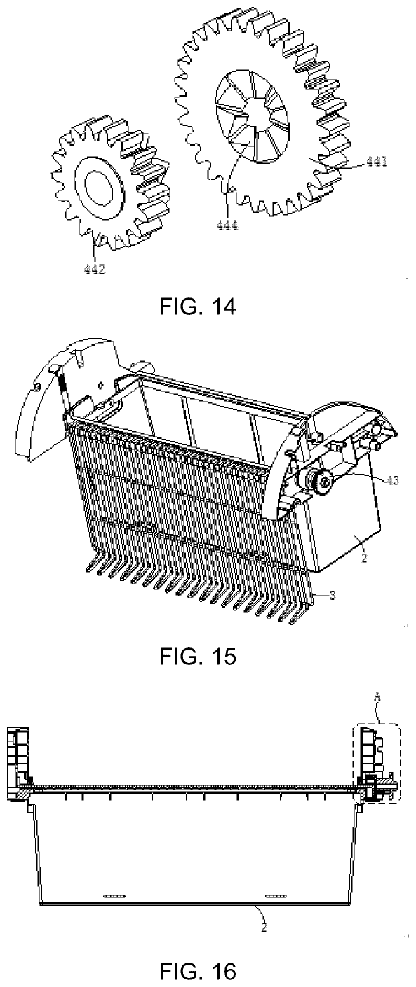

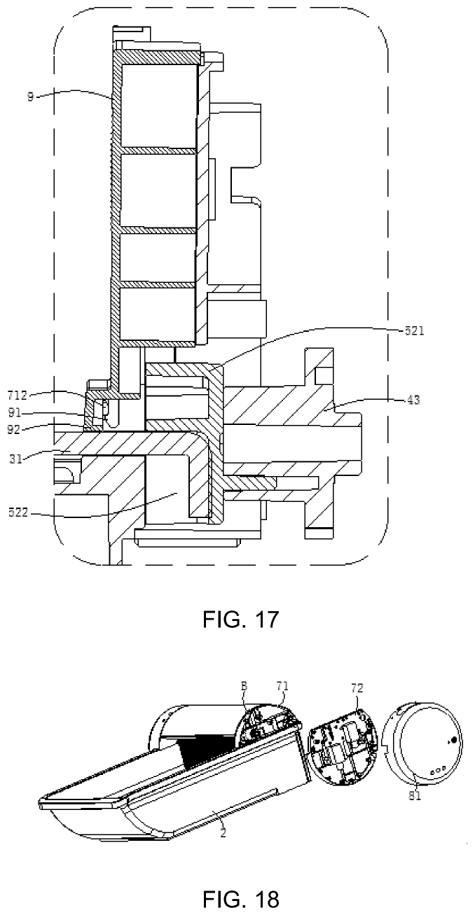

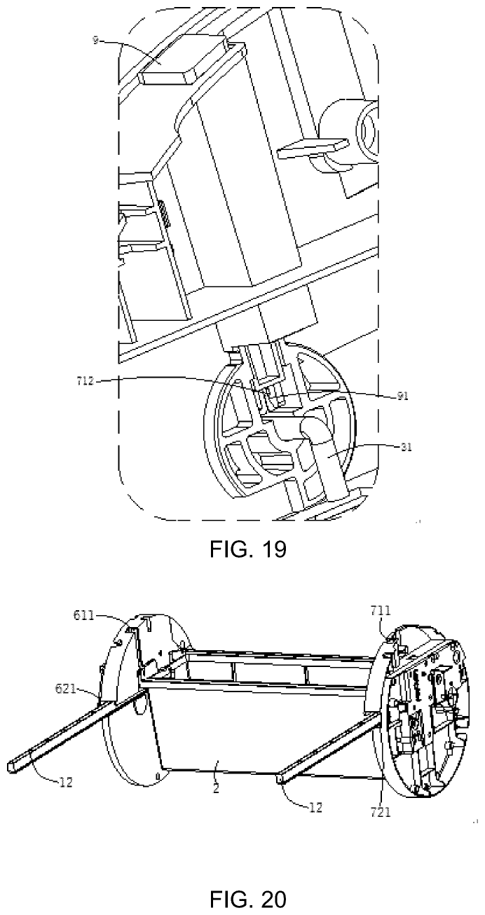

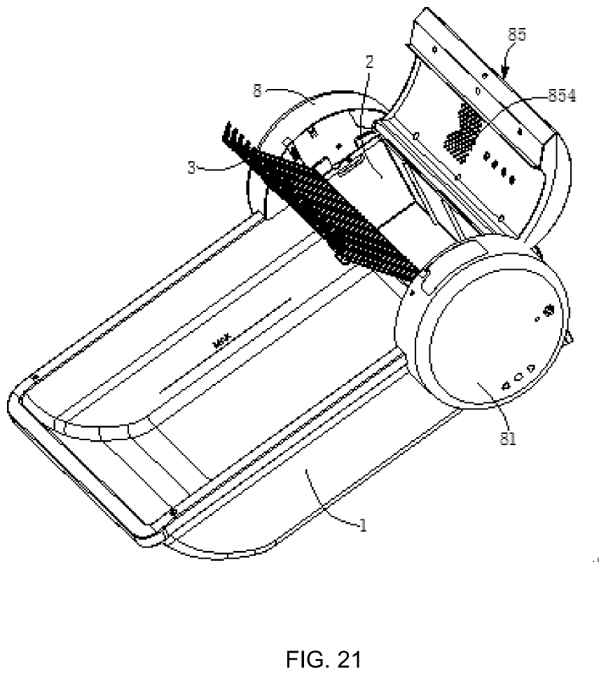

Referring to FIGS. 1 to 21, a self-cleaning cat litter box that automatically slides and flips over to scoop out feces and open a lid includes a box body 1, a trash bin 2, a poop rake 3, a trash lid 85, and a flipping drive mechanism 4. The trash bin 2 and the poop rake 3 are both housed in the box body 1, and the poop rake 3 is located on the front side of the trash bin 2. Slides are disposed on the left and right sides of the trash bin 2. The flipping drive mechanism 4 is located in one of the slides. The trash lid 85 covers the top of the trash bin 2. The poop rake 3 and the trash lid 85 are both hinged to the two slides and are driven by the flipping drive mechanism 4 to flip over synchronously. The trash bin 2, the poop rake 3 and the trash lid 85 are all slidingly connected to the box body 1 through the two slides.

Referring to FIG. 1, the top of the box body 1 is hollowed out to form a rectangular shell, the front wall of the box body 1 is arc-shaped, and the poop rake 3 can scoop the excrement inside the box body 1 out along the arc-shaped front wall of the box body 1. A long strip of boss 11 is provided inside the box body 1. The boss 11 is arranged in the width direction of the box body 1 and is located at the rear end of the box body 1. A certain drop is formed between the top of the boss 11 and the inner bottom wall of the box body 1. A rack 12 is fixed to the bottom of each of both opposite edges (i.e., the left and right edges) of the box body 1 in its length direction.

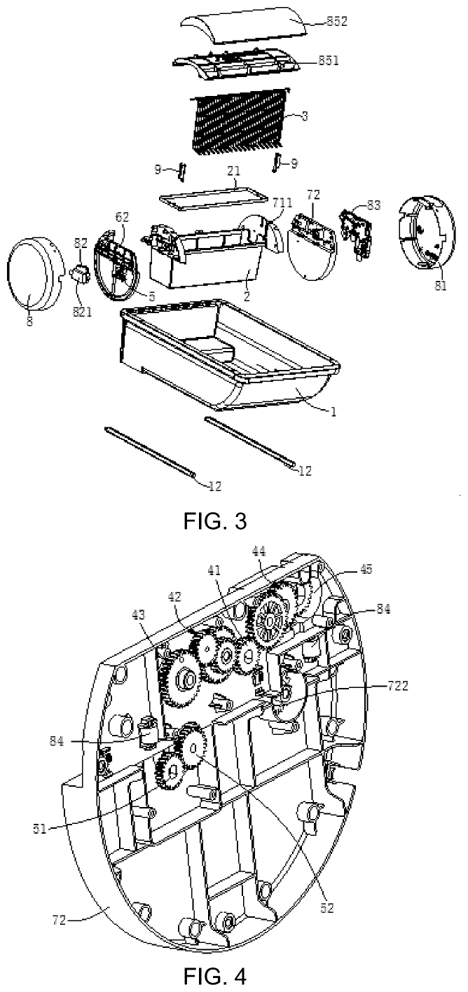

Referring to FIGS. 2 and 3, the trash bin 2 is in the shape of a rectangle and its top is hollowed out to form an opening. The entire trash bin 2 is movably arranged on the boss 11. The opening of the trash bin 2 is provided with a fixing frame 21 that is magnetically connected to the trash bin 2 for easy replacement of trash bags.

Referring to FIGS. 2, 3, 4, 5, 6, 7, 18, 19 and 20, the two slides are specifically a left slide 6 and a right slide 7. The trash bin 2, the trash lid 85, and the poop rake 3 are all located between the left slide 6 and the right slide 7. The left slide 6 includes a left side plate 61, a left fixing plate 62, and a left cover plate 82. The left side plate 61 is semicircular and located on the left side wall of the trash bin 2. The top and the inner wall of the left side plate 61 close to the trash bin 2 are together provided with a left slot 611 in the shape of a long strip. The lower ends of the two inner walls of the left slot 611 are respectively provided with clamping tables 712. The left cover plate 82 and the left fixing plate 62 are fixedly covered on the left side plate 61 in turn from the outside to the inside. Specifically, the left fixing plate 62 fixedly covers the outside of the left side plate 61, and a left chute 621 in the shape of a long strip is formed at the bottom of the left side plate 61. The left rack 12 is inserted into the left chute 621. The left rack 12 and the left edge of the box body 1 are slidably hooked in the left chute 621 together. The left cover plate 82 is fixedly covered on the left fixing plate 62 to form a left drive cavity, and a left sliding motor 821 is fixed outside the left cover plate 82. The structure of the right slide 7 is similar to that of the left slide 6. The right slide 7 includes a right side plate 71, a right fixing plate 72, and a right cover plate 83. The right side plate 71 is also semicircular and located on the right side wall of the trash bin 2. The top and the inner wall of the right side plate 71 close to the trash bin 2 are together provided with a right slot 711 in the shape of a long strip. The lower ends of both inner walls of the right slot 711 are also respectively provided with clamping tables 712. The right cover plate 83 and the right fixing plate 72 fixedly cover the right side plate 71 in turn from the outside to the inside, respectively. Specifically, the right fixing plate 72 fixedly covers the outside of the right side plate 71, and a right chute 721 in the shape of a long strip is formed at the bottom of the right side plate 71. The right rack 12 is inserted into the right chute 721. The right rack 12 and the right edge of the box body 1 are slidably hooked in the left chute 621 together. The right cover plate 83 is fixedly covered on the right fixing plate 72 to form a right drive cavity, and a flipping motor 831 and a right sliding motor 832 are fixed outside the right cover plate 83. In this embodiment, the left gliding motor 821, the flipping motor 831 and the right gliding motor 832 are all reduction motors. The left side plate 61 and the right side plate 71 are respectively located at the left and right edges of the trash bin 2. The left side plate 61, the right side plate 71, and the trash bin 2 are integrally formed from a same material. Two rollers 84 are rotatably connected on both the left fixing plate 62 and the right fixing plate 72. The two rollers 84 on the left fixing plate 62 are exposed in the left chute 621 and roll against the left edge outer wall of the box body 1, and the two rollers 84 on the right fixing plate 72 are exposed in the right chute 721 and roll against the right edge outer wall of the box body 1, making the front and back sliding of the trash bin 2, the trash lid 85 and the poop rake 3 more stable.

Referring to FIGS. 2 to 7, in order to drive the two slides, the trash bin 2, the poop rake 3, and the trash lid 85 to slide together on the box body 1, a sliding drive mechanism 5 is disposed in a drive cavity of each of the two slides (the structures of the two sliding drive mechanisms 5 are the same, the sliding drive mechanism 5 on the left side is located in the left drive cavity of the left slide 6, and the sliding drive mechanism 5 on the right side is located in the right drive cavity of the right slide 7). Each sliding drive mechanism 5 includes a sliding driving wheel 51 and a sliding driven wheel 52. The sliding driven wheels 52 are dual gears. The sliding driving wheel 51 on the left side is fixed on an output shaft of the left sliding motor 821, and a part of the sliding driven wheel 52 on the left side is exposed in the left chute 621, so that the teeth at both ends of the sliding driven wheel 52 on the left side can mesh with the sliding driven wheel 52 on the left side and the rack 12 on the left side, respectively. The sliding driving wheel 51 on the right side is fixed on an output shaft of the right sliding motor 832, and a part of the sliding driven wheel 52 on the right side is exposed in the right chute 721, so that the teeth at both ends of the sliding driven wheel 52 on the right side can mesh with the sliding driven wheel 52 on the right side and the rack 12 on the right side, respectively. The left sliding motor 821 and the right sliding motor 832 can jointly drive the two slides, the trash bin 2, the poop rake 3 and the trash lid 85 through the corresponding sliding drive mechanisms 5 to slide on the box body 1 together. An auxiliary wheel 722 is rotatably connected to the right fixing plate 72. The auxiliary wheel 722 is exposed in the right chute 721 and meshes with the rack 12 on the right side.

Referring to FIGS. 2, 3, 8, 11, 16, 17, 18 and 19, the lower end of the poop rake 3 is bent outward. A rotary shaft 31 is disposed on the top of the poop rake 3, and the poop rake 3 is hinged to two side plates (i.e., the left side plate 61 and the right side plate 71) through the rotary shaft 31. Specifically, the left end of the rotary shaft 31 extends into the left slot 611, the right end of the rotary shaft 31 passes through the right slot 711 and is bent vertically, and the bent portion of the rotary shaft 31 is located outside the right side plate 71. An insertion strip 9 is slidably mounted in each of the left slot 611 and the right slot 711. The two insertion strips 9 are arranged symmetrically. The lower end of each insertion strip 9 is provided with a limit portion 92 and two buckles 91. When the insertion strip 9 on the left end is inserted into the left slot 611, the two buckles 91 on the insertion strip 9 on the left end mesh with the two clamping tables 712 in the left slot 611 one by one, the limit portion 92 on the insertion strip 9 on the left end and the lower end of the left slot 611 form a left insertion hole, and the left end of the rotary shaft 31 extends into the left insertion hole. When the insertion strip 9 on the right end is inserted into the right slot 711, the two buckles 91 on the insertion strip 9 on the right end are engaged with the two clamping tables 712 in the right slot 711 one by one, the limit portion 92 on the insertion strip 9 on the right end and the lower end of the right slot 711 form a right insertion hole, and the left end of the rotary shaft 31 passes through the right insertion hole. A limit wheel 521 is rotatably connected between the right fixing plate 72 and the right side plate 71. A limit hole 522 is defined on the end face of the limit wheel 521. The bent portion at the right end of the rotary shaft 31 is located in the limit hole 522. When the flipping drive mechanism 4 drives the limit wheel 521 to rotate, the limit wheel 521 can drive the rotary shaft 31 to rotate, thereby controlling the flipping of the poop rake 3.

Referring to FIGS. 2, 3 and 11, the trash lid 85 includes a lid body 851 and a top cover 852. The lid body 851 and the top cover 852 are both in the shape of an arc-shaped shell. The left and right sides of the rear end of the lid body 851 are provided with rotating shafts 853, respectively. The left and right sides of the lid body 851 are respectively hinged to two side plates (i.e., the left side plate 61 and the right side plate 71) through the rotating shafts 853. The top cover 852 fixedly covers the top of the lid body 851 to form an inner cavity that is provided with a deodorizing device, and the lid body 851 is provided with a plurality of deodorizing holes 854. When the trash lid 85 is covered on the trash bin 2, the deodorizing device in the trash lid 85 can release ozone that enters the trash bin 2 through the plurality of deodorization holes 854 for deodorization and disinfection.

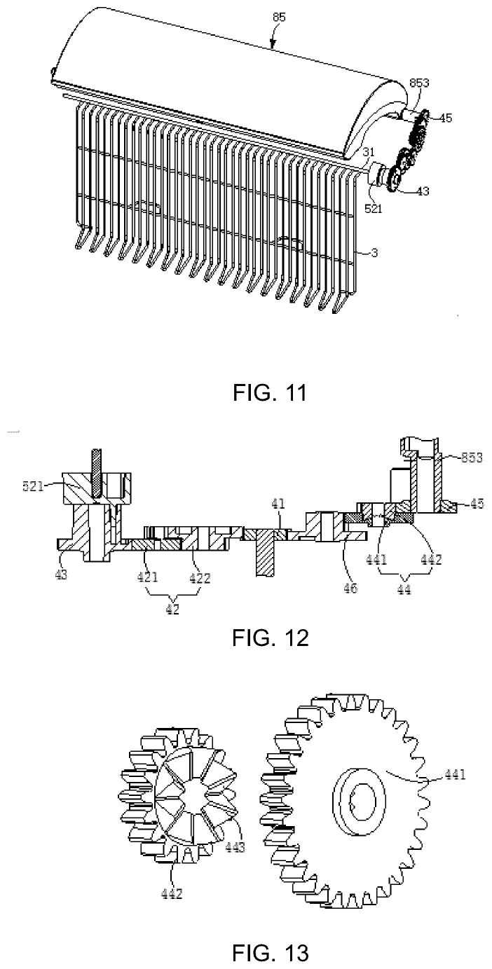

Referring to FIGS. 11 to 15, the flipping drive mechanism 4 can control the poop rake 3 and the trash lid 85 to flip over in the same direction. The rotating shafts 853 of the trash lid 85 are drivingly connected to the rotary shaft 31 of the poop rake 3 through the flipping drive mechanism 4. The flipping drive mechanism 4 is located in the right drive cavity of the right slide 7. The flipping drive mechanism 4 includes a flipping driving wheel 41, a second gear 46, a second dual gear 44, a second driven wheel 45, a first driven wheel 43, and a gear set 42. The flipping driving wheel 41 is rotatably arranged in the right slide 7 and is fixed on the output shaft of the flipping motor 831. The first driven wheel 43 and the limit wheel 521 are coaxially limitedly connected, so that the first driven wheel 43 can rotate synchronously with the rotary shaft 31 of the poop rake 3. The gear set 42 includes a first gear 421 and a first dual gear 422. The flipping driving wheel 41 meshes with the first driven wheel 43 through the first dual gear 422 and the first gear 421 in turn, so that the flipping driving wheel 41 can drive the first driven wheel 43 to rotate through the first dual gear 422, the first gear 421 and the first driven wheel 43, and then drive the limit wheel 521 and the poop rake 3 to rotate synchronously at a certain angle, thereby realizing the flipping action of the poop rake 3. The second driven wheel 45 is sleeved on the rotating shafts 853 of the trash lid 85. The flipping driving wheel 41 meshes with the second driven wheel 45 through the second gear 46 and the second dual gear 44 in turn, so that the flipping driving wheel 41 can drive the second driven wheel 45 to rotate through the second gear 46 and the second dual gear 44, and then drive the trash lid 85 to rotate at a certain angle, thereby realizing the flipping action of the trash lid 85. In order to facilitate the user to manually open the trash lid 85, the second dual gear 44 includes a third gear 441 and a fourth gear 442 that are coaxially arranged. A plurality of ratchet teeth 443 are protruded on the end face of the fourth gear 442, and the plurality of ratchet teeth 443 are spaced apart in a circle around the fourth gear 442. The end face of the third gear 441 is provided with a plurality of ratchet grooves 444 that are spaced apart in a circle around the third gear 441 and match all the ratchet teeth 443 in one-to-one correspondence concavely and convexly. The third gear 441 meshes with the second gear 46, and the fourth gear 442 meshes with the second driven wheel 45. When the flipping motor 831 stops running, the flipping driving wheel 41, the second gear 46 and the third gear 441 do not rotate. Moreover, manually flipping the trash lid 85 can make the second driven wheel 45 rotate. The second driven wheel 45 drives the fourth gear 442 to rotate, and the fourth gear 442 rotates relative to the third gear 441. During the rotating process of the fourth gear 44, the ratchet teeth 443 of the fourth gear 442 will fall into the ratchet grooves 444 of the third gear 441 and move as the fourth gear 442 rotates. When falling from one ratchet groove 444 into another ratchet groove, 444, the ratchet teeth 443 will experience a brief disengagement and re-engagement process. During this process, the friction and impact between the ratchet teeth 443 and the ratchet grooves 444 will produce a “click” sound.

Referring to FIGS. 2 and 3, the right slide 7 is also covered with a circular right side cover 81. A main control panel is disposed in the right side cover 81. The right side cover 81 is also provided with a switch, a display screen, etc. A circular left side cover 8 covers the left slide 6 outside.

Referring to FIGS. 1 to 21, the working principle of the self-cleaning cat litter box that automatically slides and flips over to scoop out feces and open a lid of the present disclosure is as follows:

The right sliding motor 832 drives the sliding driving wheel 51 on the right side to rotate, and the sliding driving wheel 51 on the right side drives the sliding driven wheel 52 on the right side to rotate; meanwhile, the left sliding motor 821 drives the sliding driving wheel 51 on the left side to rotate, and the sliding driving wheel 51 on the left side drives the sliding driven wheel 52 on the left side to rotate, so that both the left and right sliding driven wheels 52 rotate synchronously to control the left slide 6, the right slide 7, the trash bin 2, the poop rake 3, and the trash lid 85 to slide forward together on the box body 1. Moreover, the poop rake 3 pushes the cat excrement in the box body 1 forward, so that the cat excrement is accumulated;

When cat excrement is accumulated on the arc-shaped front wall of the box body 1, the flipping motor 831 drives the flipping driving wheel 41 to rotate, and the flipping driving wheel 41 drives the second driven wheel 45 to rotate through the second gear 46, the third gear 441 and the fourth gear 442 in turn, thereby driving the trash lid 85 to flip upward to open the trash bin 2. Meanwhile, the flipping driving wheel 41 drives the first driven wheel 43 to rotate through the first dual gear 422 and the first gear 421 in turn, and the first driven wheel 43 drives the limit wheel 521 to rotate synchronously, thereby driving the poop rake 3 to flip upward to scoop up the cat excrement. When the poop rake 3 and the trash lid 85 together flip upward 180 degrees, the cat excrement on the poop rake 3 can slide smoothly into the trash bin 2 (referring to FIG. 21). When the scooping is completed, the poop rake 3 and the trash lid 85 rotate and reset synchronously and then slide backward until the trash bin 2 is located on the boss 11 of the box body 1.

When the cat excrement in the trash bin 2 is full, the user can manually flip up the trash lid 85 to open the trash bin 2. Moreover, the trash lid 85 drives the second driven wheel 45 to rotate, and then drives the fourth gear 442 to rotate relative to the third gear 441 and makes a “click” sound at the same time. The user can also use the flipping motor 831 to drive the trash lid 85 and the poop rake 3 to flip upward together to open the trash bin 2. After the trash bin 2 is opened, the fixed frame 21 can be directly taken out to replace the trash bag in the trash bin 2;

When the user needs to remove the poop rake 3, the flipping motor 831 is first used to drive the trash lid 85 and the poop rake 3 to flip upward together, so that the bent portion at the right end of the rotary shaft 31 and the limit holes 522 of the limit wheel 521 are both upward. Then, the two insertion strips 9 are pulled out to release the blocking portion at the upper end of the rotary shaft 31. At this time, the poop rake 3 can be manually taken out along the left slot 611 and the right slot 711;

When it is needed to mount the poop rake 3, the user manually mounts the poop rake 3. Then, the two insertion strips 9 are inserted, and the flipping motor 831 reverses to drive the trash lid 85 and the poop rake 3 to flip downward and reset together, so that the poop rake 3 can return to its original position;

By using the self-cleaning cat litter box that automatically slides and flips over to scoop out feces and open a lid of the present disclosure, the automation of a series of operations such as poop scooping, collection and capping is realized through an ingenious mechanical structure design, which greatly improves the user experience. During the working process, the trash bin 2, the poop rake 3, and the trash lid 85 as a whole slide along the box body 1 under the guidance of the slides. The poop rake 3 first slides in the box body 1 to gather the cat's excrement into a pile, and then, the flipping drive mechanism 4 drives the poop rake 3 and the trash lid 85 to flip at the same time. During this process, the trash lid 85 is opened, and the opening of the trash bin 2 is exposed. Meanwhile, the poop rake 3 scoops up the collected excrement and sends the same into the trash bin 2. After the scooping action is completed, the flipping drive mechanism 4 works again to reset the poop rake 3 and the trash lid 85, and the trash lid 85 re-closes the trash bin 2 to ensure that the trash does not leak out and keep the cat litter box clean and hygienic.

By using the self-cleaning cat litter box that automatically slides and flips over to scoop out feces and open a lid of the present disclosure, comprehensive automation of the cat litter box cleaning process is realized through an integrated mechanical structure and an intelligent control system, which not only simplifies the cleaning process and improves the cleaning efficiency, but also greatly reduces the complexity and the labor intensity of manual operations. Moreover, since the trash lid 85 will be covered simultaneously during the cleaning process, the diffusion of odor and the spread of germs in the trash bin 2 are effectively avoided, creating a healthier and more comfortable living environment for pets and pet owners.

The above disclosure is merely preferred embodiments of the present disclosure and cannot be used to limit the scope of protection of the present disclosure. Therefore, equivalent changes made in the patent scope of the present disclosure still fall within the scope of the present disclosure.

1. A self-cleaning cat litter box that automatically slides and flips over to scoop out feces and open a lid, comprising a box body, wherein a trash bin and a poop rake are housed in the box body, the poop rake is located on the front side of the trash bin, slides are disposed on the left and right sides of the trash bin, a flipping drive mechanism is disposed in one of the slides, the top of the trash bin is covered with a trash lid, the poop rake and the trash lid are both hinged to the two slides and are driven by the flipping drive mechanism to flip over synchronously, and the trash bin, the poop rake, and the trash lid are all slidingly connected to the box body through the two slides.

2. The self-cleaning cat litter box that automatically slides and flips over to scoop out feces and open the lid according to claim 1, wherein a top end of the poop rake is hinged to the two slides through a rotary shaft, a rear end of the trash lid is hinged to the two slides through rotating shafts, and the poop rake and the trash lid flip over in a same direction.

3. The self-cleaning cat litter box that automatically slides and flips over to scoop out feces and open the lid according to claim 1, wherein a chute is disposed on an inner wall of each of the slides close to the trash bin, and both opposite edges of the box body are slidably hooked in the two chutes, respectively.

4. The self-cleaning cat litter box that automatically slides and flips over to scoop out feces and open a lid according to claim 3, wherein racks are respectively fixed at the bottoms of both opposite edges of the box body, the two racks are inserted into the two chutes in a one-to-one correspondence manner, sliding drive mechanisms are respectively disposed on the two slides, and sliding driven wheels of the sliding drive mechanisms are exposed in the chutes and mesh with the corresponding racks.

5. The self-cleaning cat litter box that automatically slides and flips over to scoop out feces and open a lid according to claim 3, wherein each of the slides is rotatably connected with a roller, and the rollers are exposed in the corresponding chutes and roll against an edge outer wall of the box body.

6. The self-cleaning cat litter box that automatically slides and flips over to scoop out feces and open a lid according to claim 1, wherein the flipping drive mechanism comprises a flipping driving wheel, a second gear, a second dual gear, and a second driven wheel, the flipping driving wheel being rotatably arranged in the slides and driving the second driven wheel to rotate through the second gear and the second dual gear in turn, and the second driven wheel being sleeved on the rotating shafts of the trash lid.

7. The self-cleaning cat litter box that automatically slides and flips over to scoop out feces and open a lid according to claim 6, wherein the second dual gear comprises a third gear and a fourth gear that are coaxially arranged, an end face of the third gear matching an end face of the fourth gear concavely and convexly, the third gear meshing with the second gear, and the fourth gear meshing with the second driven wheel.

8. The self-cleaning cat litter box that automatically slides and flips over to scoop out feces and open a lid according to claim 6, wherein the flipping drive mechanism further comprises a first driven wheel and a gear set, the first driven wheel and the rotary shaft of the poop rake rotating synchronously, and the flipping driving wheel driving the first driven wheel to rotate through the gear set.

9. The self-cleaning cat litter box that automatically slides and flips over to scoop out feces and open a lid according to claim 1, wherein a slot is disposed on both the top and inner wall of each of the slides, an insertion strip is mounted in each slot, the insertion strips are slidably engaged in the slots to form insertion holes, and the rotary shaft of the poop rake extends into the insertion holes.

10. The self-cleaning cat litter box that automatically slides and flips over to scoop out feces and open a lid according to claim 1, wherein a limit wheel is rotatably disposed in one of the slides, the end of the rotary shaft of the poop rake is bent and located in the limit wheel, and the limit wheel is driven by the flipping drive mechanism to rotate; each of the slides comprises a side plate, a fixing plate, and a cover plate, the side plates being located at the edge of the trash bin and being integrally formed with the trash bin, and the cover plates and the fixing plates fixedly covering the side plates in turn from the outside to the inside, respectively; the opening of the trash bin is magnetically connected with a fixing frame, the top of the box body is hollow and a boss is provided inside, the trash bin is movably disposed on the boss, and a deodorizing device is disposed on the trash lid.
